(19) United States
(12) Patent Application Publication
(10) Pub. No.: US 2017/0034031 A1
(43) Pub. Date: Feb. 2, 2017

(54) AUTOMATIC DETERMINATION OF OPTIMAL TIME WINDOW FOR MIGRATION, BACKUP OR OTHER PROCESSES

(71) Applicant: DELL PRODUCTS L.P., Round Rock, TX (US)

(72) Inventor: Tom Willis, Madison, WI (US)

(21) Appl. No.: 14/815,221

(22) Filed: Jul. 31, 2015

(51) Int. Cl. H04L 12/26

(52) U.S. Cl. CPC H04L 43/0882; H04L 43/045; H04L 43/067

(57) ABSTRACT

A system for estimating network loading comprising a component selection system configured to receive a selection of two or more components in a user-defined network out of a plurality of available network components. A window analysis system configured to receive the two or more selected components and to generate a component loading display that shows component loading as a function of time for one or more metrics associated with each component.

### TECHNICAL FIELD

The present disclosure relates generally to network management, and more specifically to a system and method for automatic determination of an optimal time window for migration, backup or other processes on a network.

### BACKGROUND OF THE INVENTION

Currently, it is known to monitor the use of open systems interconnect (OSI) layer 1 (physical) through layer 3 (network) levels of the OSI model for a network, to assist a dynamic controller with allocation and distribution of network bandwidth in a multi-protocol label switch. However, such processes do not facilitate determination of an optimal time window for migration, backup or other processes that utilize processing resources of other OSI layers.

### SUMMARY OF THE INVENTION

A system for estimating network loading is disclosed that includes a component selection system that receives a selection of two or more components in a user-defined network out of a plurality of available network components. A window analysis system receives the two or more selected components and generates a component loading display that shows component loading as a function of time for one or more metrics associated with each component.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for automatic determination of a time window for migration, backup or other processes, in accordance with an exemplary embodiment of the present disclosure;

FIG. 2 is a diagram of an algorithm for automatic determination of a time window for migration, backup or other processes, in accordance with an exemplary embodiment of the present disclosure;

FIG. 3 is a diagram of a user-defined network loading with a single peak, in accordance with an exemplary embodiment of the present disclosure;

FIG. 4 is a diagram of a user-defined network loading with multiple peaks for a first function, in accordance with an exemplary embodiment of the present disclosure; and

FIG. 5 is a diagram of a user-defined network loading with multiple peaks for a second function, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

As noted, the prior art discloses a dynamic controller that is used to allocate and distribute network bandwidth in a multi-protocol label switch for the physical (layer 1) through network (layer 3) levels of the OSI model. Such processes do not aid with scheduling or run-time throttling of processes at the OSI transport layer (layer 4) and application layer (layer 7), which should be based on historical data, not live or dynamic data. By monitoring historical data on the usage of these network resources, as well as other important system resources like CPU usage on a source or target server or disk input/output (I/O) rates, meaningful data can be provided for use in scheduling migration, back-up or other such processes that are resource intensive at these OSI layers.

The present disclosure utilizes components to measure the network bandwidth consumption over a user-selected part of a network between a source and a target, and over a time period of interest, to develop a time series over a time range of interest (days, weeks, weekdays, weekends) from which the best time windows can be selected for performing network bandwidth intensive functions such as backup or migration. In this regard, “bandwidth” is not simply the data transfer capacity of the network, which is an OSI level 1 through level 3 metric, but rather the capability for the servers, databases, routers, firewalls and other network components between the user-selected endpoints to perform the selected function. Such functions are generally performed at OSI layer 4 and layer 7, but could include other suitable OSI layer functionality. As such, in order to determine the bandwidth, it is not only necessary to know the associated function that is to be performed, it is also important to know how each component that is required to perform that function is loaded, as a single component that is heavily loaded could result in a significant loss of bandwidth even when all other components are unloaded and available to perform the selected function.

In this regard, it is important for the exact network route that is to be used for the bandwidth-consuming operation (including but not limited to migration, backup, archiving, file transfer) to be identified, which can require an operator to either perform the selected operation on a limited scale and to monitor which components are used, or to otherwise accurately model the operation using other processes so that the operator can be notified of the necessary components and of any options. Optimal windows for the bandwidth-intensive operations can be calculated automatically or may optionally include feedback from an administrator. One or more windows may be found in a time period of interest (day, weekday, weekend period, work week), during sustained periods of low consumption of the relevant network resources. The automated application of these data processing functions to the problem of the scheduling of operations such as migrations, backup, file transfer and archiving is thus one aspect of the present disclosure.

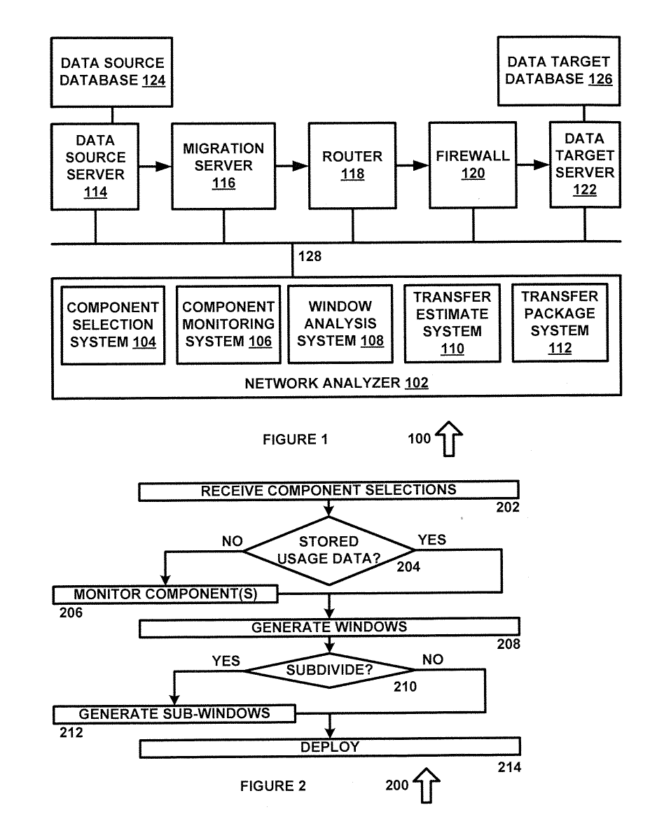

FIG. 1 is a diagram of a system 100 for automatic determination of a time window for migration, backup or other processes, in accordance with an exemplary embodiment of the present disclosure. System 100 can be implemented in hardware or a suitable combination of hardware and software.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

System 100 includes network analyzer 102, which further includes component selection system 104, component monitoring system 106, window analysis system 108, transfer estimate system 110 and transfer package system 112, each of which can be implemented as one or more hardware systems or a suitable combination of hardware and software. Network analyzer 102 is further coupled to data source server 114, migration server 116, router 118, firewall 120 and data target server 122 over network 128, and can also be directly coupled to data source database 124 and data target database 126, can be coupled to those components through data source server 114 and data target server 122 as shown, or can be coupled in other suitable manners.

In this exemplary embodiment, data source server 114 can be a suitable server, such as a Novel GroupWise mail server, and data target server 122 can be a different server that is operationally or functionally related to data source server 114, such as a Microsoft Exchange server, and where the enterprise is migrating from the Novel GroupWise mail server to the Microsoft Exchange server. These servers are provided for exemplary purposes only, and other suitable functions can also or alternatively be performed by data source server 114 and data target server 122, such as a source file server and a target file storage device, a source application server and a target alternate application server, and so forth. During the migration, data will need to be transferred from data source server 114, through migration server 116, router 118 and firewall 120 before reaching data target server 122. The route that would be taken during the bandwidth-consuming operation (e.g. migration or backup) defines the network under study, which thus excludes other network systems and components that are not part of that route, even though such other network components can impose loading on the components that are part of the route and which will therefore have an impact on the bandwidth of the route. Network traffic across this user-defined network can be measured over time by a suitable system, such as the Dell Foglight® system, the open source rrdtool, a Dell managed network switch like the Dell PowerConnect®, or other suitable systems or devices, to develop a time series of bandwidth consumption by each selected component.

Component selection system 104 receives two or more component selections that are used to define the user-selected network. In one exemplary embodiment, component selection system 104 can generate a graphic user interface that displays a network topology map by detecting components on a network, and can receive a user selection of two or more end point components, one or more intervening components and other suitable components associated with a predetermined function, including but not limited to migration, backup, archiving and file transfer. Component selection system 104 can also or alternatively generate selected components that can be required for a predetermined function, such as to assist the user with identification of all necessary components, to prompt the user to select one or more redundant components or for other suitable purposes.

Component monitoring system 106 monitors network component bandwidth metrics, such as data transfer capacity and loading, processing capacity and loading, random access memory capacity and loading, database performance, mail store performance, mail server application performance, relative virtual machine performance or other suitable metrics, and stores the monitored metric over time for subsequent analysis and monitoring. In one exemplary embodiment, component monitoring system 106 can continuously monitor metrics for all network components, can monitor metrics for user-selected components over a user-selected period of time, or can perform other suitable functions. In this exemplary embodiment, components that are impacted by a function that is performed by other components can be identified, such as to identify components that should be included in a user-defined network for a predetermined function or other suitable components.

Window analysis system 108 receives use metrics for two or more components in a user-selected network and generates usage data in a suitable format to allow a user to determine an optimal period for performing a predetermined function, including but not limited to migration, backup, archiving and file transfer. In one exemplary embodiment, window analysis system 108 can generate a loading diagram to allow a user to visually determine the optimal periods for performing such functions. In another exemplary embodiment, window analysis system 108 can receive data from transfer estimate system 110, transfer package system 112 or other suitable systems and can generate modified loading diagrams that show the loading before and after implementing a plan for a predetermined function, including but not limited to migration, backup, archiving and file transfer.

Transfer estimate system 110 receives user-selected network data and data defining a predetermined function, including but not limited to migration, backup, archiving and file transfer, and generates estimate data for performing the predetermined function with the user-selected network. In one exemplary embodiment, transfer estimate system 110 can store metric data for the predetermined function as it was previously performed on the same or other systems, on the same or other user-defined networks or other suitable data that can be used to provide an estimate of the length of time, loading, resources or other factors associated with the predetermined function. In another exemplary embodiment, transfer estimate system 110 can generate estimates for metrics based on known parameters, such as processing speeds, file sizes, loading and other parameters for components in a user-defined network.

Transfer package system 112 receives data for a user-defined network and a predetermined function, and generates distinct packages that can be independently processed for the predetermined function. In one exemplary embodiment, the predetermined function can include a migration from a first system to a second system, where the entire organization needs to be migrated at the same time, such as over a weekend. Transfer package system 112 can allow a user to structure the migration as a function of a time zone for each user, such as to start the migration for users on the east coast of the U.S. first and to add users from other time zones at predetermined times, such as 5:00 pm on Friday for each time zone. Likewise, backup, archiving, file transfer and other suitable functions can be packaged to allow the function to be performed at optimal times, such as to backup or archive files for a first set of users over a first week, for a second set of users over a second week and so forth, to transfer files for a first set of users at a first time of day and for a second set of users at a second time of day, and so forth.

In operation, system 100 allows a user to analyze a user-defined network to determine the optimal periods for performing a function, so as to minimize the impact on normal operations, to stage the function and to otherwise manage the function to prevent inadvertent downtime or misoperation of the components of the user-selected network.

FIG. 2 is a diagram of an algorithm 200 for automatic determination of a time window for migration, backup or other processes, in accordance with an exemplary embodiment of the present disclosure. Algorithm 200 can be implemented in hardware or a suitable combination of hardware and software. Although algorithm 200 is shown as a flowchart, object oriented programming, state diagrams or other suitable programming paradigms can also or alternatively be used to implement algorithm 200.

Algorithm 200 begins at 202 where component selections are received to create a user-defined network. In one exemplary embodiment, the user-defined network can be generated by selecting two end points, an associated function that is to be performed (including but not limited to migration, backup, archiving and file transfer), by selecting components between the end points to perform the function, or in other suitable manners. The user-defined network can be selected from components that are automatically detected, can be entered by the user or other suitable processes can also or alternatively be used. The algorithm then proceeds to 204.

At 204, it is determined whether there is stored usage data. In one exemplary embodiment, usage data for network components can be stored on an ongoing basis, such as by monitoring processor load, dynamic access memory usage, data transmission bandwidth or other suitable metrics. If it is determined that there is stored usage data, then the algorithm proceeds to 208, otherwise the algorithm proceeds to 206.

At 206, the components of the user-selected network are monitored for usage data. In one exemplary embodiment, a user can be prompted to select types of metrics as a function of component, time periods and other suitable monitoring data. In another exemplary embodiment, all metrics for all components in the user-defined network can be monitored. Likewise, other suitable processes can also or alternatively be used. The algorithm then proceeds to 208.

At 208, the usage data is used to generate network loading, bandwidth and usage windows. In one exemplary embodiment, a loading curve can be generated that shows percentage of capacity that is available as a function of time. In another exemplary embodiment, available time windows for the selected function can be generated, loading curves showing component loading while the process is being performed, or other suitable data can be generated. The algorithm then proceeds to 210.

At 210, it is determined whether the function can be subdivided. If the function cannot be subdivided, the algorithm proceeds to 214 where the function is deployed, otherwise the algorithm proceeds to 212 where sub-windows are generated. In one exemplary embodiment, a sub-window can be generated and modified as a function of a subset of data that can be separately processed for the selected function, such as to identify a group of users that can be migrated separately from other users, a group of users in a different time zone, to add or delete users from groups, to change the order of subsets, or to performs other suitable functions on subsets of users. The algorithm then proceeds to 214.

In operation, algorithm 200 allows a user-defined network to be identified and further allows a function that is to be performed on the user-defined network, including but not limited to migration, backup, archiving and file transfer, to be identified and modelled. Algorithm 200 thus allows a user to schedule functions for a user-defined network at times when the normal operation of the components of the user-defined network will not be adversely affected.

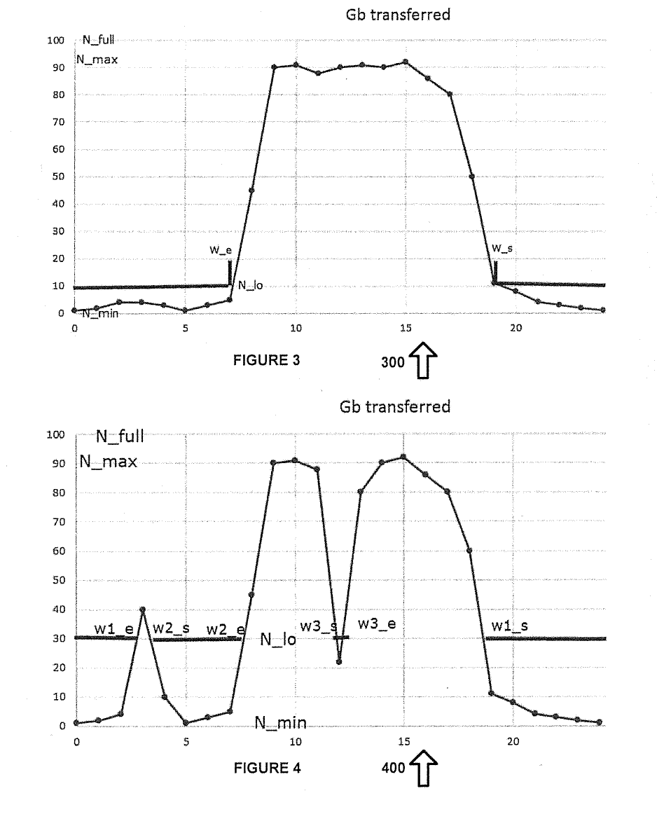

FIG. 3 is a diagram 300 of a user-defined network loading with a single peak, in accordance with an exemplary embodiment of the present disclosure. In a simple case, as for the network of a single-location business where work normally occurs between 9:00 am and 5:00 pm, the bandwidth consumption can be represented by the data set of diagram 300, where the lowest bandwidth consumption is designated Nmin, the highest recorded consumption is Nmax, and the maximum possible bandwidth is N_full. The bandwidth amount that distinguishes a low-usage time period from a high-consumption time period is Nlo. In this case, looking for an operations window across the period of a day, the automatically calculated operations window is from W_s in the evening to W_e in the early morning. The vertical axis is bandwidth consumed across the measured section of network at a given time. The horizontal axis is hour of the day.

FIG. 4 is a diagram 400 of a user-defined network loading with multiple peaks for a first function, in accordance with an exemplary embodiment of the present disclosure. Diagram 400 shows a more complicated network usage pattern, including an early morning spike due to some other network activities such as batch emails, and a mid-day slump in usages when the workers normally go to lunch. In this example, there are three possible operations windows for a function: the evening until the batch operations are performed, the morning after batch operations are performed, and a narrow lunchtime window, defined by the start/stop pairs (w1_s, w1_e), (w2_s, w2_e) and (w3_s, w3_e). The administrators may elect not to use an operations windows as narrow as the mid-day gap, so a minimum width of the operations window can be defined. In addition, the administrator can manually define restricted time windows, and the generated operations windows can reflect these manually-defined parameters. The windows can be different for different days of the week. The period over which windows are automatically calculated would normally be a day, but any suitable interval can also or alternatively be used.

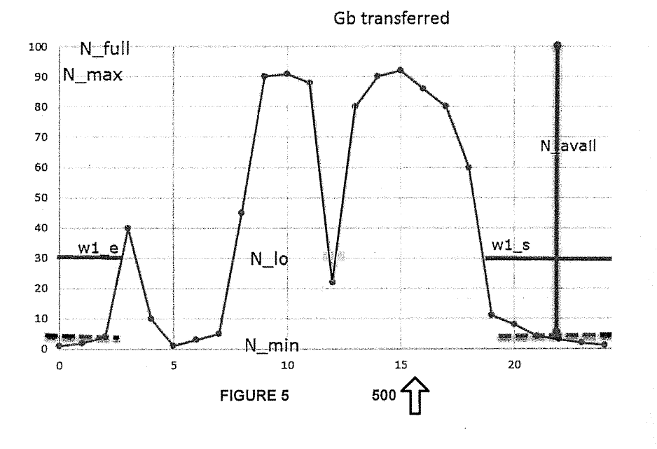

FIG. 5 is a diagram 500 of a user-defined network loading with multiple peaks for a second function, in accordance with an exemplary embodiment of the present disclosure. The general amount of bandwidth typically available to a bandwidth-consuming operation in a given time window can also or alternatively be provided, from the vertical measurement n_avail, as shown. Migration, archiving, backup and other products that have controllable network metric consumption parameters can be controlled to adjust their usage not to exceed the expected amount of bandwidth available in a given window.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for estimating network loading comprising:
a component selection system configured to receive a selection of two or more components in a user-defined network out of a plurality of available network components; and
a window analysis system configured to receive the two or more selected components and to generate a component loading display that shows component loading as a function of time for one or more metrics associated with each component.

2. The system of claim 1 further comprising a component modelling system configured to monitor each of the selected components to generate usage data for the one or more metrics for each component.

3. The system of claim 1 further comprising a transfer estimate system configured to identify an estimated period of time required to perform a user-selected process as a function of the one or more metrics associated with each component and a loading for each component associated with the user-selected process.

4. The system of claim 1 further comprising a transfer package system configured to identify a plurality of estimated periods of time during which a user-selected process can be performed as a function of the one or more metrics associated with each component, a loading for each component associated with the user-selected process, and variables associated with the user-selected process.

5. The system of claim 1 wherein the component selection system is configured to detect each of the plurality of available components and to generate a user-selectable display showing each of the plurality of available components.

6. The system of claim 1 wherein the component selection system is configured to detect each of the plurality of available components, to generate a user-selectable display showing each of the plurality of available components, and to receive a user selection of two endpoints of the user-defined network.

7. The system of claim 1 wherein the component selection system is configured to detect each of the plurality of available components, to generate a user-selectable display showing each of the plurality of available components, to receive a user selection of two endpoints of the user-defined network, and to generate a list of components between the user-defined endpoints for a user-selected process.

8. A method for estimating network loading comprising:
receiving a selection of two or more components in a user-defined network out of a plurality of available network components through a user interface device of a processor; and
generating a component loading display on the user interface device of the processor that shows component loading as a function of time for one or more metrics associated with each component.

9. The method of claim 8 further comprising:
monitoring each of the selected components with a monitoring system; and
generating usage data for the one or more metrics for each component as a function of the monitoring.

10. The method of claim 8 further comprising identifying an estimated period of time required to perform a user-selected process as a function of the one or more metrics associated with each component and a loading for each component associated with the user-selected process.

11. The method of claim 8 further comprising identifying a plurality of estimated periods of time during which a user-selected process can be performed as a function of the one or more metrics associated with each component, a loading for each component associated with the user-selected process, and variables associated with the user-selected process.

12. The method of claim 8 comprising:
detecting each of the plurality of available components; and
generating a user-selectable display showing each of the plurality of available components.

13. The method of claim 8 further comprising:
detecting each of the plurality of available components;
generating a user-selectable display showing each of the plurality of available components; and
receiving a user selection of two endpoints of the user-defined network.

14. The method of claim 8 further comprising:
detecting each of the plurality of available components;
generating a user-selectable display showing each of the plurality of available components;
receiving a user selection of two endpoints of the user-defined network; and
generating a list of components between the user-defined endpoints for a user-selected process.
